(19) United States
(12) Patent Application Publication
(10) Pub. No.: US 2017/0063493 A1
(43) Pub. Date: Mar. 2, 2017

(54) METHODS AND CIRCUITS FOR PERFORMING CYCLIC REDUNDANCY CHECK (CRC) OF AN INPUT DATA STREAM

(71) Applicant: Signalchip Innovations Private Limited, Bangalore (IN)

(72) Inventors: Rajesh Mundhada, Bangalore (IN); Avinash Giridhar, Bangalore (IN); Chinmayananda Arunachala, Bangalore (IN)

(21) Appl. No.: 15/042,404

(22) Filed: Feb. 12, 2016

(30) Foreign Application Priority Data
Aug. 25, 2015 (IN) 4467/CHE/2015

(51) Int. Cl. H04L 1/00; G06F 11/10

(52) U.S. Cl. CPC H04L 1/0061; G06F 11/1004

(57) ABSTRACT

A method for performing cyclic redundancy check of an input data stream includes a) obtaining plurality of segments of the input data stream, b) computing a CRC for each of the plurality of segments for obtaining a plurality of partial CRCs, c) initializing a register with a partial CRC of N^{th} segment of the plurality of segments, d) performing a Boolean operation on the partial CRC of N^{th} segment to obtain a first intermediate CRC based on a length of (N−1)^{th} segment of the plurality of segments, e) adding the first intermediate CRC to a partial CRC of (N−1)^{th} segment to obtain a second intermediate CRC, and f) repeating steps d) and e) until a partial CRC associated with a least significant segment of the plurality of segments is added to a first intermediate CRC corresponding to a second segment of the pluralityy of segments to obtain a final CRC.

### CROSS REFERENCE

This application claims priority to Indian patent application no. 4467/CHE/2015 filed on Aug. 25, 2015, the complete disclosure of which, in its entirety, is herein incorporated by reference.

### BACKGROUND

Technical Field

The embodiments herein generally relate to a system and a method for validating transmitted data or received data, and, more particularly, to a system and a method for validating transmitted data or received data by computing cyclic redundancy check (CRC) of a data stream by combining CRCs of segments of data stream using a CRC combiner which reduces a hardware area and a number of clock cycles.

Description of the Related Art

In telecommunication, error detection and correction or error control are techniques that enable reliable delivery of digital data over unreliable communication channels. Many communication channels are subject to channel noise, and thus errors may be introduced during transmission from the source to a receiver. Error detection techniques allow detecting such errors, while error correction enables reconstruction of the original data in many cases. In several communication systems, the error correction may be validated using cyclic redundancy check (CRC). Cyclic redundancy check (CRC) refers to an error-detecting code commonly used in digital networks and storage devices to detect accidental changes in raw data. Pursuant to an exemplary scenario, blocks of data entering the communication systems may get a short check value attached based on the remainder of a polynomial division of their contents, on retrieval the calculation is repeated, and corrective action may be taken against presumed data corruption if the check values do not match.

Conventional CRC computation for high throughput applications requires segmenting input data stream into multiple segments and computing CRCs of each of the segments. These CRCs are appended with variable number of zeroes based on the segment number and a CRC is computed on each of the resulting streams producing intermediate CRCs. These intermediate CRC outputs are then XORed to compute the final CRC of the input stream of data as described in the FIG. 1. FIG. 1 illustrates a typical CRC computation system. The CRC computation system includes one or more sub-streams 102 A-N, CRCs 104A-N each corresponds to each of the sub-streams 102 one or more CRC operation units 106A-N, and a XOR operation unit 108. The input data stream S is segmented into one or more sub-streams 102A-N (e g., S1, S2, S3, and S4) of equal length. For each sub-stream, a CRC is computed using a CRC computing unit. CRCs 104A-N are appended with variable number of zeroes and intermediate CRCs are computed on the resulting streams using one or more “shift and intermediate CRC compute” units 106A-N. The resulting intermediate CRCs are XORed by the XOR operation unit 108 to obtain a final CRC 110 of the input data stream. Combining the sub-stream CRCs can be defined using the following equation,

CRC(M)=CRC(Σᵢ₌₀^{N-1}Cᵢx^{i*k})

Another conventional approach replaces each of n*(N−K) shift of FIG. 1 by a CRC shift logic which performs the equivalent operation of shifting (by appending zeroes) and taking the CRC of the resulting stream. This “CRC shift” logic is performed in 1 clock cycle in contrast to n*(N−1) clock cycles in the above mentioned implementation. But this requires, N−1 different “CRC shift” logic circuits corresponding to shifts varying from n to n*(N−1) (in steps of n) for different segments as shown below. This increases the hardware area, though the number of clock cycles is reduced to 1 clock when all “CRC shift” logic circuits are run in parallel. The overall shifting logic (which is the sum of all “CRC shift” logic area) consumes more hardware area as the number of segments increase.

During decoding process in the receiver, the data stream is processed in segments to decode the segments in parallel. Inherently, the CRC requires the complete packet of data stream to be available for computation. When data is available in segments and/or when there is a high throughput requirement for the CRC computation, the CRC is computed on the segments, and the results are combined to get the final CRC. The shifting logic increases area in hardware as the length of the message increases. This affects the high throughput requirement when the parallel CRC computation is required.

Accordingly, there remains a need for a system and method that computes parallel CRCs, and combines the parallel CRC efficiently to reduce memory requirements, clock cycles, and/or latency.

### SUMMARY

In view of foregoing embodiments herein is provided a method of performing cyclic redundancy check (CRC) of an input data stream. a) A plurality of segments corresponding to the input data stream is obtained. b) A CRC is computed for each of the plurality of segments for obtaining a plurality of partial CRCs. c) A register is initialized with a partial CRC of N^{th} segment of the plurality of segments. The N^{th} segment is a most significant segment of the plurality of segments of the input data stream. d) A Boolean operation is performed, using at least one Boolean function unit, on the partial CRC of N^{th} segment to obtain a first intermediate CRC based on a length of (N−1)^{th} segment of the plurality of segments. e) The first intermediate CRC is added to a partial CRC of (N−1)^{th} segment of the plurality of segments to obtain a second intermediate CRC. f) The steps d) and e) are repeated until a partial CRC associated with a least significant segment of the plurality of segments is added to a first intermediate CRC corresponding to a second segment of the plurality of segments to obtain a final CRC corresponding to the input data stream.

The final CRC of the input data stream may be computed in accordance with an equation CRC(M)=CRC(CRC(CRC . . . (CRC(CRC(S_{N-1}*x^{L}^{_{N−2}}+S_{N-2})*x^{L}^{_{N−3}}+S_{N-3})*x^{L}^{_{N−4}}+S_{N-4}) . . . *x^{L}^{₁}+S₁)*x^{L}^{₀}+S₀), where CRC (M) represents the final CRC of the input data stream (M), and Sᵢ₊₁*x^{L}^{ᵢ} represents padding Lᵢ zeroes to Sᵢ₊₁. The S_{N-1} is a most significant segment, L_{N-2} is a length of a second most significant segment. S_{N-2} is the second most significant segment, L_{N-3} is a length of a third most significant segment, S_{N-3} is the third most significant segment, L_{N-4} is a length of a fourth most significant segment, S_{N-4} is the fourth most significant segment, L₁ is a length of a second least significant segment, S₁ is the second least significant segment, L₀ is a length of a least significant segment, and S₀ is the least significant segment.

The final CRC of the input data stream may be computed in accordance with an equation CRC(M,G)=F(F . . . (F((F(C_{N-1},L_{N-2},G)+C_{N-2}),L_{N-3},G), . . . +C₁)L₀,G)+C₀). The F is Boolean operation for a particular CRC polynomial, Cᵢ is a CRC of a particular segment i, L_{N-2} is an amount of zero padding based on a length of a third most significant segment, L_{N-3} is an amount of zero padding based on a length of a fourth most significant segment, L₀ is an amount of zero padding based on a length of a least significant segment, and G is a generator polynomial. The Boolean operation (F), for a particular CRC polynomial G, may be implemented in k stages. A stage ‘t’ of the k stages includes a Boolean function, that performs CRC of an input of the stage ‘t’ padded with 2^{t} zeroes, which may be implemented using a XOR operator per output bit j that ranges from 0 to r−1 on a predetermined set of selected input bits of the stage ‘t’ based on a generator polynomial G, t and j. Each output of the Boolean function may be selected as an output of a stage when a bit Lᵢ₍ₜ₎ is 1, where T is equal to 0:(k−1). The k stages is equal to r stages, where r is a number of bits required to represent a length Lᵢ in binary form as Lᵢ₍ᵣ₋₁₎ to Lᵢ₍₀₎.

A stage ‘t’ of the k stages includes a Boolean function, that performs CRC of an input of the stage ‘t’ padded with 2^{Xt} zeroes, implemented using a XOR operator per output bit j that ranges from 0 to r−1, on a predetermined selected input bits of the each stage based on a generator polynomial G, t and j. The ‘t’ ranges from 0 to (k−1) and sum of Xt is Lᵢ. In one embodiment, the Boolean function may be implemented using other possible logic operators. Boolean operation (F), for a selectable CRC polynomial G, may be implemented in r stages, r being a number of bits required to represent a length Lᵢ in binary form as Lᵢ₍ᵣ₋₁₎ to Lᵢ₍₀₎. A stage ‘t’ of the r stages includes a Boolean function, that performs CRC of an input of said stage ‘t’ padded with 2^{t} zeroes, which may be implemented using a XOR operator per output bit j that ranges from 0 to r−1, on input bits corresponding to the ‘t’ stage and are selected by G, t, and j. The j is stage output hit position of the stage ‘t’. Each output of the Boolean function ay be selected as an output of a stage when a bit Lᵢ₍ₜ₎ is 1. The input data stream may include a plurality of segments of equal size. The input data stream may include at least one segment which differs in size with respect to other segments of the plurality of segments.

In another aspect, a cyclic redundancy check combiner circuit is provided. The CRC combiner circuit includes a register for storing partial CRCs of a plurality of segments corresponding to an input data stream, a Boolean function unit communicatively associated with the register for performing a Boolean operation on partial CRC of an N^{th} segment from among the plurality of segments to obtain an intermediate CRC based on a length of (N−1)^{th} segment of the plurality of segments, and an XOR unit communicatively associated with the Boolean function unit for adding the intermediate CRC to a partial CRC of (N−1)^{th} segment of the plurality of segments to obtain a second intermediate CRC. The N^{th} is a most significant segment of the plurality of segments of the input data stream. The XOR unit may add a partial CRC associated with a least significant segment of the plurality of segments to a first intermediate CRC corresponding to a second segment of the plurality of segments to obtain a final CRC corresponding to the input data stream.

The final CRC of the input data stream may be computed in accordance with an equation CRC(M)=CRC(CRC(CRC . . . (CRC(CRC(S_{N-1}*x^{L}^{_{N−2}}+S_{N-2})*x^{L}^{_{N−3}}+S_{N-3})*x^{L}^{_{N−4}}+S_{N-4}) . . . *x^{L}^{₁}+S₁)*x^{L}^{₀}+S₀), where CRC (M) represents the final CRC of the input data stream (M), and Sᵢ₊₁*x^{L}^{ᵢ} represents padding Lᵢ zeroes to Sᵢ₊₁. The S_{N-1} is a most significant segment, L_{N-2} is a length of a second most significant segment, S_{N-2} is the second most significant segment, L_{N-1} is a length of a third most significant segment, S_{N-3} is the third most significant segment, L_{N-4} is a length of a fourth most significant segment, S_{N-4} is the fourth most significant segment, L₁ is a length of a second least significant segment, S₁ is the second least significant segment, L₀ is a length of a least significant segment, and S₀ is the least significant segment.

The final CRC of the input data stream may be computed in accordance with an equation CRC(M,G)=F(F . . . (F((F(C_{N-1},L_{N-2},G)+C_{N-2}),L_{N-3},G), . . . +C₁)L₀,G)+C₀). The F is Boolean operation for a particular CRC polynomial, Cᵢ is a CRC of a particular segment i, L_{N-2} is an amount of zero padding based on a length of a third most significant segment, L_{N-3} is an amount of zero padding based on a length of a fourth most significant segment, L₀ is an amount of zero padding based on a length of a least significant segment, and G is a generator polynomial. The Boolean operation (F), for a particular CRC polynomial G, may be implemented in k stages. A stage ‘t’ of the k stages includes a Boolean function, that performs CRC of an input of the stage ‘t’ padded with 2^{t} zeroes, which may be implemented using a XOR operator per output bit j that ranges from 0 to r−1, on a predetermined set of selected input bits of the stage ‘t’ based on a generator polynomial G, t and j. Each output of the Boolean function may be selected as an output of a stage when a bit L^{i(t)} is 1, where ‘t’ is equal to 0:(k−1). The k stages are equal to r stages, and where r is a number of bits required to represent a length Lᵢ in binary form as Lᵢ₍ᵣ₋₁₎ to Lᵢ₍₀₎.

A stage ‘t’ of the k stages includes a Boolean function, that performs CRC of an input of the stage ‘t’ padded with 2^{Xt} zeroes, implemented using a XOR operator per output bit j that ranges from 0 to r−1, on a predetermined selected input bits of the each stage based on a generator polynomial G, t and j. The ‘t’ ranges from 0 to (k−1) and sum of Xt is Lᵢ. In one embodiment, the Boolean function may be implemented using other possible logic operators. Boolean operation (F), for a selectable CRC polynomial G, may be implemented in r stages, r being a number of bits required to represent a length Lᵢ in binary form as Lᵢ₍ᵣ₋₁₎ to Lᵢ₍₀₎. A stage ‘t’ of the r stages includes a Boolean function, that performs CRC of an input of said stage ‘t’ padded with 2^{t} zeroes, which may be implemented using a XOR operator per output bit j that ranges from 0 to r−1, on input bits corresponding to the ‘t’ stage and are selected by G, t, and j. The j is stage output bit position of the stage ‘t’. Each output of the Boolean function may be selected as an output of a stage when a bit Lᵢ₍ₜ₎ is 1. The input data stream may include a plurality of segments of equal size.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a typical CRC computation system;

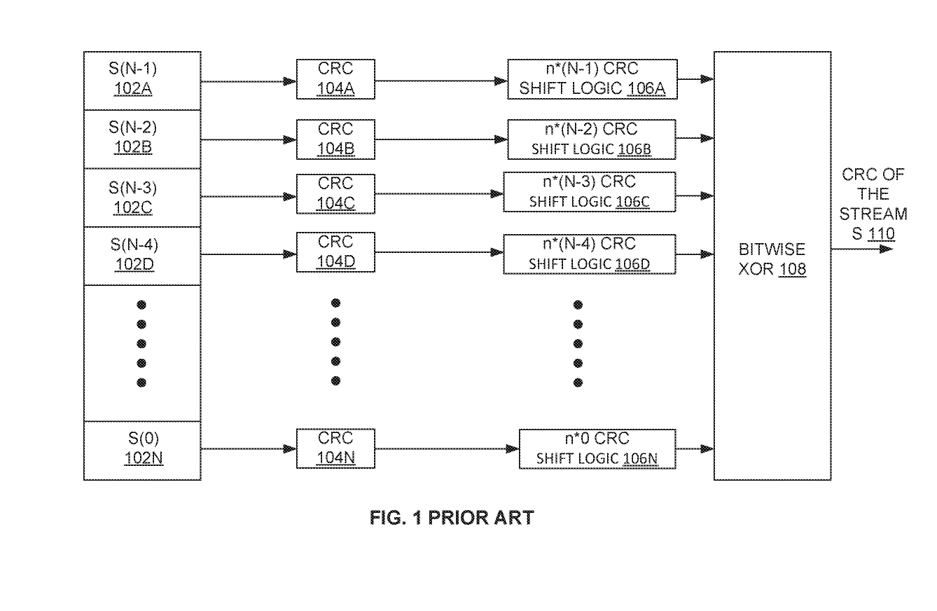

FIG. 2 illustrates a CRC computing system for computing a CRC of an input data stream according to an embodiment herein;

FIG. 3A is an exploded view of a CRC combiner circuit of the CRC computing system of FIG. 2 according to an embodiment herein;

FIG. 3B is an exploded view of a CRC combiner with a selectable generator polynomial according to another embodiment herein;

FIG. 4A illustrates a diagrammatic process flow depicting a process of generating a 5 bit CRC according to an embodiment herein;

FIG. 4B illustrates Boolean operations for a 5 bit CRC according to an embodiment herein;

FIG. 5A illustrates a Boolean function unit of the CRC combiner circuit of FIG. 3A according to an embodiment herein;

FIG. 5B illustrates a Boolean function unit of the CRC combiner circuit FIG. 3A, according to another embodiment herein;

FIG. 6 is an exploded view of the Boolean function F2power(t) which constitutes a stage in the Boolean function unit 304 of FIG. 5A and FIG. 5B, according to an embodiment herein;

FIG. 7A is an exploded view of a pre calculated bit selection unit of the Boolean Function F2power(t) of FIG. 6, according to an embodiment herein;

FIG. 7B is an exploded view of a pre calculated bit selection unit of the Boolean Function F2power(t) of FIG. 6 with a predetermined generator polynomial according to an embodiment herein; and

FIG. 8 is a flow diagram illustrating a method of computing CRC for an input data stream using the CRC computing system according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

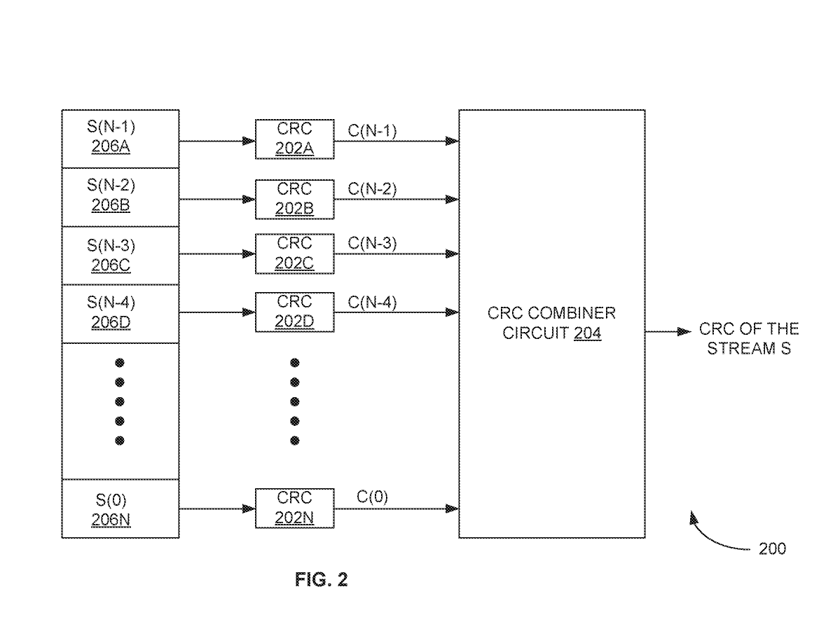

As mentioned, there remains a need for a system and a method that computes segment CRCs, and combines the segment CRCs to reduce the hardware area and the number of clock cycles. Referring now to the drawings, and more particularly to FIGS. 2 through 8 where similar reference characters denote corresponding features consistently throughout the figures, there are shown preferred embodiments.

FIG. 2 illustrates a CRC computing system 200 for computing a CRC of an input data stream according to an embodiment herein. The CRC computing system 200 includes one or more CRC computing unit 202A-N and a CRC combiner circuit 204. In one embodiment, the CRC computing system 200 segments the input data stream into a plurality of segments 206A-N. In another embodiment, the CRC computing system 200 receives the input data stream as a plurality of segments 206A-N which are already segmented. The one or more CRC computing unit 202A-N computes a CRC associated with each segment of the plurality of segments 206A-N. The CRC combiner circuit 204 receives partial segment CRCs associated with each of the plurality of segments 206A-N, and computes a final CRC of the input data stream.

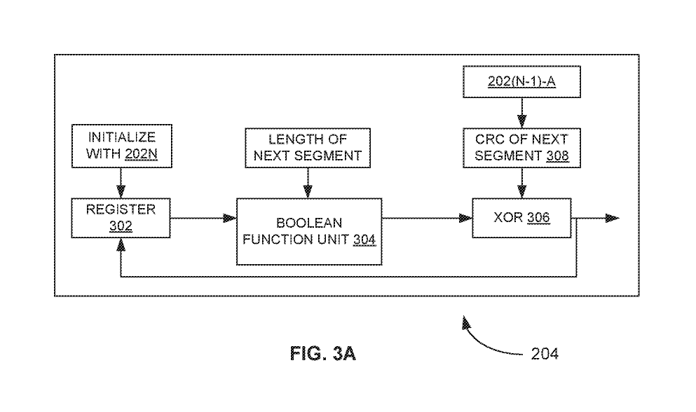

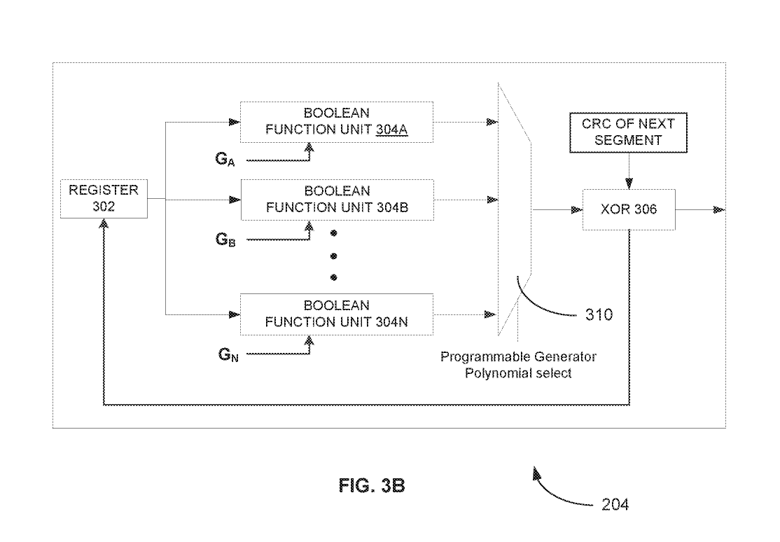

FIG. 3A is an exploded view of the CRC combiner circuit 204 of the CRC computing system of FIG. 2 according to an embodiment herein. The CRC combiner circuit 204 includes a register 302, a Boolean function unit 304, and a XOR unit 306. The CRC combiner circuit 204 is configured to compute a final CRC of the input data stream in multiple stages based on a number of partial segment CRCs obtained from the CRC computing units 202A-N. The register 302 is initialized with a partial CRC of N^{th} segment of a plurality of segments of the input data stream. The N^{th} segment is a most significant segment of the plurality of segments of the input data stream. The Boolean function unit 304 performs a Boolean operation on the partial CRC of the N^{th} segment to obtain a first intermediate CRC of a first stage based on a length of (N−1)^{th} segment of the plurality of segments. The XOR unit 306 adds the first intermediate CRC of the first stage to a partial CRC of next segment 308 (i.e., (_{N-1})^{th} segment) of the plurality of segments to obtain a second intermediate CRC of the first stage.

The second intermediate CRC of the first stage is provided as an input to the register 302, which again undergoes a Boolean operation based on a length of the (N−2) segment of the plurality of segments to obtain a first intermediate CRC of a second stage. The XOR unit 306 adds the first intermediate CRC of the second stage to a partial CRC of next segment 308 (i.e., (N−2)^{th} segment) of the plurality of segments to obtain a second intermediate CRC of the second stage. The steps of performing a Boolean operation by the Boolean function unit 304 and adding a first intermediate CRC of a stage to a partial CRC of a next most significant segment by the XOR unit 306, are repeated until a partial CRC associated with a least significant segment of the plurality of segments is added to a first intermediate CRC corresponding to a second segment of the plurality of segments to obtain a final CRC of the input data stream. Consider for example, if the input data stream is segmented into 3 segments (the most significant segment S₂, the intermediate segment S₁, and the least significant segment S₀) of equal or unequal size. The segment CRC associated with the segment S2, S1, S0 are C₂. C1 and C0 respectively. The CRC combination of the 3 segments CRCs is performed over 2 stages. In the first stage, the register 302 is initialized with the segment CRC (C₁). The Boolean function unit 304 performs a Boolean operation on the segment CRC C₂, based on the length of segment S1 to obtain a first intermediate CRC of the first stage. The XOR unit 306 adds the first intermediate CRC of the first stage to the segment CRC C₁ to obtain a second intermediate CRC of the first stage.

In the second stage, the register 302 is initialized with the second intermediate CRC of the first stage. Thus, the register 302 stores the segment CRC associated with the segment S2 of the input data stream initially, and subsequently stores one or more intermediate CRCs computed at one or more stages of computing a final CRC of the input data stream. The Boolean function unit 304 performs a Boolean operation on the second intermediate CRC based on a length of segment S0 to obtain a first intermediate CRC of the second stage. The XOR unit 306 adds the first intermediate CRC of the second stage to the segment CRC of the segment S0 to obtain a final CRC of the input data stream.

FIG. 3B is an exploded view of a CRC combiner circuit 204 with a selectable generator polynomial, in accordance with another embodiment. The CRC combiner circuit 204 as depicted in FIG. 3B is a variation of the CRC combiner circuit 204 of FIG. 3A with the generator polynomial G being made selectable. The CRC combiner circuit includes Boolean function units 304A-N, each processing the CRC for a particular generator polynomial from among a plurality of selectable generator polynomials G_{A}-G_{N}. A multiplexer 310 is used to select the output of a particular Boolean function unit from among the Boolean function units 304 A-N based on selection of a particular generator polynomial from among the plurality of selectable generator polynomials used as the mux select. The output of the multiplexer is then XORed with the CRC of the next segment and stored in the register and the recursive process continues until all the segment CRCs have been combined to produce the final CRC. For the purpose of illustration the multiplexer in the figure is depicted to be outside and separate from the Boolean function units 304A-N, however it is noted that in several embodiments the multiplexer may form an integral component of the Boolean function units 304A-N or a single Boolean function unit 304.

In one embodiment, a final CRC of a message (M) is computed in accordance with an equation

CRC(M)=CRC(CRC(CRC . . . (CRC(CRC(S_{N-1}*x^{L}^{_{N−2}}+S_{N-2})*x^{L}^{_{N−3}}+S_{N-3})*x^{L}^{_{N−4}}+S_{N-4}) . . . *x^{L}^{₀}+S₁)*x^{L}^{₀}+S₀), where M is divided into “N” segments Sₚ of lengths Lₚ. The segments are of same or different lengths with p=0 to N−1, where p=N−1 corresponds to a most significant segment and p=0 corresponds to a least significant segment.

The below table indicates an example of computing a final CRC of an input data stream consisting 4 segments S₃, S₂, S₁ and S₀ of length L₃, L₂, L₁ and L₀ and having segment CRC C₃, C₂, C₁ and C₀ respectively using the CRC combiner circuit 204 disclosed herein. As indicated in the table, when S₃ is most significant segment and S₀ is least significant segment. In this example segment lengths are L₃=20, L₂=53, Lᵢ=31 and L₀=44.

| | | Length of | | |
|---|---|---|---|---|
| | | segments provided | | |
| | | as input to the | | |
| Stage | Contents of the | Boolean function | Input to the | Output of the XOR |
| number | register 302 | unit 304 | XOR unit 306 | unit 306 |
| i = 1 | C_{N-1,3} = C₃ | 53 = L₂. | C₂ | Stored back as C_{N-1,2} |
| i = 2 | C_{N-1,2} | 31 = L₁. | C₁ | Stored back as C_{N-1,1} |
| i = 3 | C_{N-1,1} | 44 = L₀. | C₀ | C_{N-1,0} - Output of |
| | | | | XOR block |

A mathematical expression for computing a final CRC of an input data stream (Message M) using the CRC combiner circuit 204 is described below. When an input data stream is divided into segments of equal lengths or unequal lengths, the lengths of segments depend on a size of the input data stream. Hence, the Boolean function unit 304 makes a shift amount to be configurable. For a shift amount “R” which requires r bits for its representation in binary system, a maximum shift of 2^{r}−1 can be accommodated by the same circuit.

Let M be a message of length “K” bits divided into “N” segments of equal length “n” bits each. The message is divided into segments of consecutive bits.

M=M_{N-1}∥M_{N-2}∥ . . . ∥M₁∥M₀ (1)

where ∥ represents concatenation of bits.

Each Mᵢ , where i=0 to N−1 is a segment of n bits as shown below.

Mᵢ=Mᵢ(n−1)∥Mᵢ(n−2)∥ . . . ∥Mᵢ(1)∥Mᵢ(0) (2)

In polynomial form, Mᵢ is written as

$$\begin{matrix}{M}_{i} ( x ) = {M}_{i} ( n - 1 ) * {x}^{( ( i * n ) + n - 1 )} + {M}_{i} ( n - 2 ) * {x}^{( ( i * n ) + n - 2 )} + … + {M}_{i} ( 1 ) * \\ {x}^{( ( i * n ) + 1 )} + {M}_{i} ( 0 ) * {x}^{( ( i * n ) + 0 )} \\ = {x}^{i * n} * [ \begin{matrix}{M}_{i} ( n - 1 ) * {x}^{( n - 1 )} + {M}_{i} ( n - 2 ) * {x}^{( n - 2 )} + … + \\ {M}_{i} ( 1 ) * {x}^{( 1 )} + {M}_{i} ( 0 ) * {x}^{( 0 )}\end{matrix} ] \\ = {x}^{i * n} * {M}_{i}^{′} ( x ) ( 4 )\end{matrix} \qquad ( 3 )$$

In polynomial form, M can be written as

M(x)=M_{N-1}(x)+M_{N-2}(x)+ . . . +M₁(x)+M₀(x) (5)

Substituting each of Mᵢ(x) to form the polynomial form of M,

M(x)=M_{N-1}′(x)*x^{(N-1)*(n)}+M_{N-2}′(x)*x^{(N-2)*(n)}+ . . . +M₀′(x)*x^{(1)*(n)}+M₀′(x)*x^{(0)*(n)} (6)

CRC of a message polynomial for a given generator polynomial is the remainder of the message polynomial when divided by the generator polynomial. Hence CRC can also be defined as

CRC(M)=mod(M(x),G(x)) (7)

G(x) is the generator polynomial for the CRC

Applying modulo to M(x) and using distributive property of modulo operation.

CRC(M)=mod([x^{(N-1)*(n)}*mod(M_{N-1}′(x),G(x))+x^{(N-2)}*(n)*mod(M_{N-2}′(x),G(x))+ . . . +x^{(1)*(n)}*mod(M₁′(x),G(x))+x^{(0)*(n)}*mod(M₀′(x),G(x))],G(x)) (8)

Letting Cᵢ=mod(Mᵢ′(x),G(x)) (9)

Hence equation (8) can be written compactly as,

CRC(M)=CRC[x^{(N-1)*(n)}*C_{N+1}+x^{N-2)*(n)}*C_{N-2}+ . . . +x^{(1)*(n)}*C₁+x^{(0)*(n)}*C₀] (10)

From prior art, the parallel CRC can be written concisely as

CRC(M)=CRC(Σᵢ₌₀^{N-1}Cᵢx^{i*n}) (11)

The CRC has some interesting properties due to its definition in equation (7)

If A and B are two binary streams, then

CRC(A*B)=CRC(CRC(A)*CRC(B)) (12)

CRC(xⁿ*B)=CRC(xⁿ*CRC(B)) (13)

Applying equation (13) to first two terms of equation (10), we get

CRC (x^{(N-1)*(n)}*C_{N-1}+x^{(N-2)*(n)}*C_{N-2})=CRC(x^{(N-2)*(n)}*CRC(x⁽ⁿ⁾*C_{N-1}+C_{N-2})) (14)

The expression within outer CRC in equation (8), can be expressed in a nested form by applying equation (13) recursively as shown in equation (14).

CRC(M)=CRC(CRC(CRC . . . (CRC(CRC(C_{N-1}*xⁿ+C_{N-2})*xⁿ+C_{N-3})*xⁿ+C_{N-4}) . . . *xⁿ+C₁)*xⁿ+C₀) (15)

Defining C′(0)=C_{N-1}, (16)

And using the above recursive relation for i=1 to N−1

C′(i)=CRC(C′(i−1)*xⁿ+C_{N-i-1}) (17)

CRC(M)=C′(N−1) (18)

Where multiplication (*) by xⁿ is right shift (by appending n zeros) n bits and addition (+) is XOR in hardware.

Equation (11) can also be written in another form as shown below due to the distributive property of modulo operation

CRC(M)=Σᵢ₌₀^{N-1}CRC(Cᵢx^{i*n}) (19)

Implementing the above equation in hardware requires the CRC of segment i, which is C₁ , to be shifted by i*n bits by inserting those many zeroes and taking CRC of the resulting sequence. Each of the above calculated CRCs (after zero insertion and additional CRC) are then XORed to give the final CRC of the input data stream. This requires a maximum shift of (N−1)*n and taking CRC of a resulting sequence which requires (N−1)*n clock cycles for completion.

This prior art implementation is improved by using the CRC combiner circuit 204, which is equivalent to operation of zero appending a data stream and computing CRC on a resulting stream. In one embodiment, when implemented using equation (19), the CRC combiner circuit 204 requires 1 clock cycle for completion. The logic associated with each segment is different as shift length required for each segment is different.

Using equation (15) with the CRC combiner circuit 204, there is a requirement for only one value of shift that is n. Hence, using the CRC combiner 204 reduces area requirement and computation is done recursively over N cycles. In an example embodiment, implementing the equation (19) requires variable shifts for each segment CRC, which is as large as 1000*7 when a segment size n=1000 and number of segments is 8. Typically, a hardware area required to compute, CRC with variable shifts, is over 50K NAND gates. Implementing equation (15) requires constant shift of n=1000. The hardware area to compute this shift using the CRC combiner circuit 204 is 5 k NAND gates.

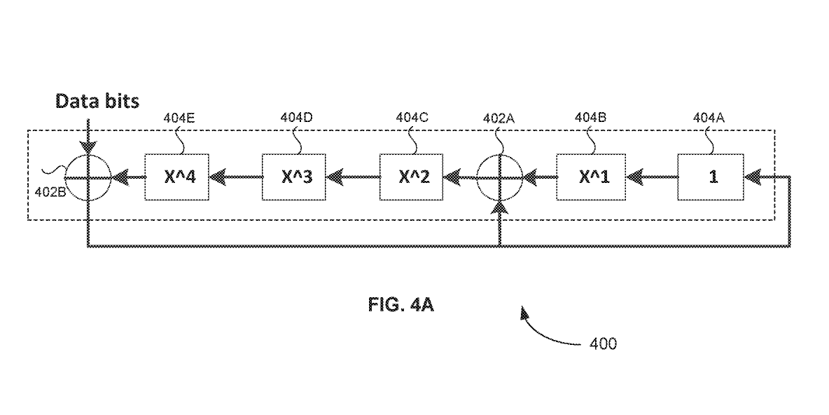

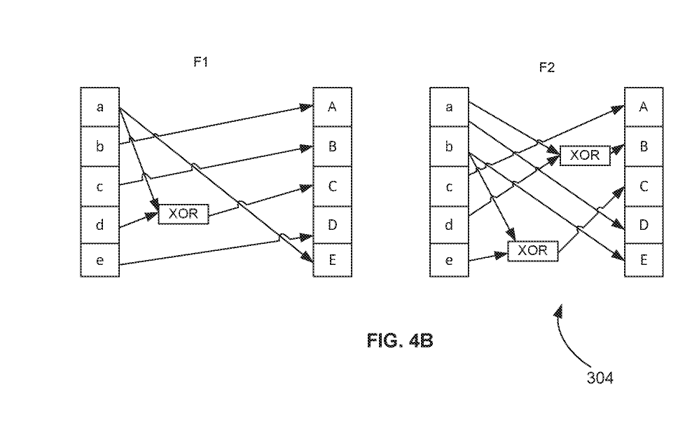

With reference to FIG. 4A and FIG. 4B, FIG. 4A illustrates a diagrammatic process flow 400 depicting a process of generating a 5 bit CRC according to an embodiment herein. With reference to FIG. 4A, consider for example a generator polynomial G=x⁵+x²+1 as generator polynomial for a 5 bit CRC. The powers of x (other than x⁰), in G, determine a position of adders in a CRC circuit. In the example given above, it is at position 2 (corresponding to x²) after 2 registers and at a position 5 (corresponding to x⁵) after 5 registers. The CRC unit 400 includes XOR blocks or one bit adders 402A-B and a plurality of one bit registers 404A-E. At every clock cycle, one data bit enters the CRC combiner circuit 204 as shown in the FIG. 4A and influences value in the bit registers 404A-E. When a register is preceded by an adder 402B the present data bit affects its value directly. Otherwise, the bits are shifted to next registers as shown by arrows. When all bits are processed, contents of the registers 404A-E give a final CRC.

Let M be a message of any length and its 5-bit CRC be represented as {a, b, c, d, e}. The 5-bit CRC “a” to “e” is bit values in the bit registers 404A-E from left to right respectively after all data bits are processed by the CRC circuit. This instant of time is denoted as “t₀”. Assuming that M is padded with a single zero. In the next clock pulse (at time t₀+1), an input data bit for the CRC circuit would be zero and the bit registers 404A-E would get updated as shown below in the below table. Updated values form CRC of the data padded with one zero. If M is padded with 2 zeroes, in a next clock pulse (at time t₀+2), the input data bit for the CRC circuit would be zero and the updated register contents are shown below in the below table. After padding a given number of zeroes and taking CRC over a resulting stream, a resulting CRC is derivable from unpadded CRC.

| Register name as in figure | | | | | | |
|---|---|---|---|---|---|---|
| above. | X⁴ | X³ | X² | X¹ | 1 | Function |
| Contents at t0 | a | b | c | d | e | — |
| Contents at t0 + 1 | b | c | a + d | e | a | F₁ |
| CRC([M 0]) | | | | | | |
| Contents at t0 + 2 | c | a + d | b + e | a | b | F₂ |
| CRC([M 0 0]) | | | | | | |

{A, B, C, D, and E} are outputs of Boolean function units (e.g., F₁ and F₂) as depicted in FIG. 4B.

In general, every bit of CRC output of zero appended input stream is a function of CRC bits of original data. Mapping to a CRC bit of padded data from the CRC bits of unpadded data depends on amount of zero padding and a generator polynomial (as the generator polynomial decides which registers are directly influenced by an input data bit).

The Boolean function F applied on its input C_{N-1,i} and given amount of zero pad “Lᵢ”, is mathematically equivalent to F(C_{N-1,i-1},Lᵢ,G)=CRC(x^{Li}*S_{N-1,i}). Segment S_{N-1,i} is the segment of message M, formed by concatenation of segments from S_{N-1} to Sᵢ (i.e., a segment of n bits), where N>i. The arguments of F show the dependence of F on the zero padding amount Lᵢ and generator polynomial G. This is equivalent to padding an input S_{N-1,i} with “Lᵢ” zeros and then taking CRC of the resulting stream. Since the function F is dependent on a number of padded zeroes (Lᵢ), given an arbitrary shift Lᵢ, it can be represented as an r bit number [Lᵢ(r−1) Lᵢ(r−2). Lᵢ(1) Lᵢ(0)] where

Lᵢ=2^{r-1}*L_{i(r-31 1)}+2^{r-2}*Lᵢ₍ᵣ₋₂₎+2^{r-3}*Lᵢ₍ᵣ₋₃₎+ . . . +2¹*Lᵢ₍₁₎+2⁰*L₀₍₀₎

r is a number of binary bits used to represent a shift L_{i.}

Lᵢ₍ᵣ₋₁₎ to Lᵢ₍₀₎ are bit values of binary representation of L_{i.}

For example if Lᵢ=9=8+1=1001 in binary system

x^{Li}*Cᵢ=x⁹*Cᵢ=x⁸*x¹*Cᵢ=x⁸*(x¹*Cᵢ)

By the property of CRC, CRC (x^{Li}*Cᵢ)=CRC (x⁸*CRC (x¹*Cᵢ))

FIG. 4B illustrates a Boolean operation for a 5 bit CRC according to an embodiment herein. Based on the above equations, with reference to FIG. 4B, the Boolean function unit 304 constructs Boolean functions F₁ (which corresponds to taking CRC(x¹*Cᵢ)) and F₈ (which corresponds to taking CRC(x⁸*Cᵢ) and passes Ci through a cascade of the two Boolean functions, to obtain a required result. F₁ and F₈ depend on the generator polynomial. When the shift required is Lᵢ=8, then passing Cᵢ through F₈ is enough. Similarly when Lᵢ=1, passing Cᵢ through F₁ will suffice. Hence, with F₁ and F₈ functions available, shifts of R=0, 1, 8 and 9 are processed. Similarly, to support all padding of length 0 to 15, the Boolean function unit 304 performs Boolean operations including F₁, F₂, F₄ and F₈. Thus, when a maximum segment length is represented in r bits, all segment lengths from 0 to 2^{r-31 1} are processed by having only r Boolean functions and appropriately combining outputs of those r Boolean functions. These r Boolean functions depend on the choice of generator polynomial.

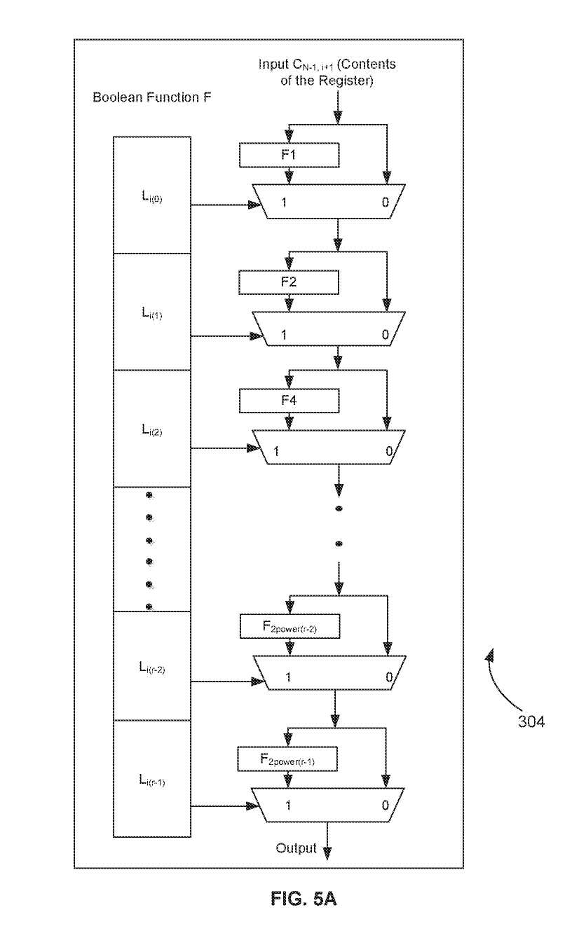

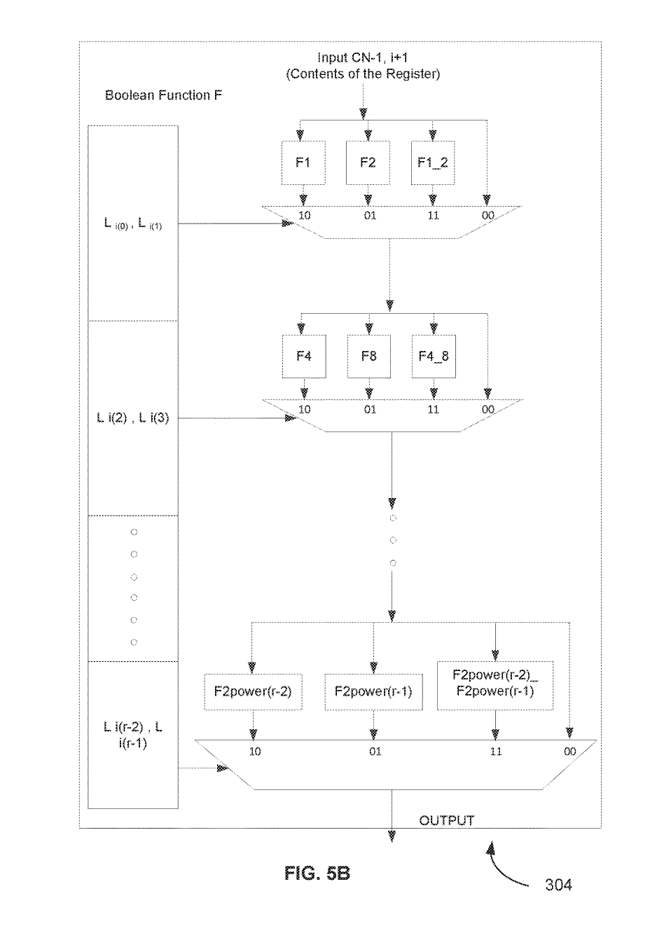

FIG. 5A illustrates a Boolean function unit 304 of the CRC combiner circuit 204 of FIG. 3A according to an embodiment herein. As described in the above example, whenever a bit value in position “t” is 1 (t=0: r−1), in a binary representation of Lᵢ, then the Boolean function for shifting by 2^{t} (which is shown F2power(t) in FIG. 5A) is applied using 2:1 multiplexers and an input is processed by that Boolean function unit 304 to obtain an output at the corresponding 2:1 multiplexer as shown in the FIG. 5A. When a bit value in position “t” is 0 (t=0: r−1), in a binary representation of Lᵢ, then the Boolean function is not applied and an input is not subjected to the Boolean function or Boolean function is bypassed.

FIG. 5B illustrates a Boolean function unit of the CRC combiner circuit of FIG. 3A, according to another embodiment herein. As illustrated in FIG. 5B, the r bits representing segment length Lᵢ are taken 2 at a time and a 4:1 multiplexer is used to make the selection between the outputs of 2 consecutive Boolean functions F2power(n) or F2power(n+1) (n=0,2,4 . . . to r−1) or a cascaded version of the two. For example, if the bits 0 and 1 at step 1 are set (1, 0) then output of F₁ is taken; if the bits are(0, 1) then output of F₂ is taken and if the bits are (1, 1), then the output of Boolean function F₁_{_}2 is taken which is a equivalent of cascaded version of Boolean functions F₁ and F₂ If the bits are (0, 0) then the Boolean functions are bypassed. This variation is representative only and can be further expanded to select between outputs of increasing number of Boolean functions using 8:1 and 16:1multiplexers and so on.

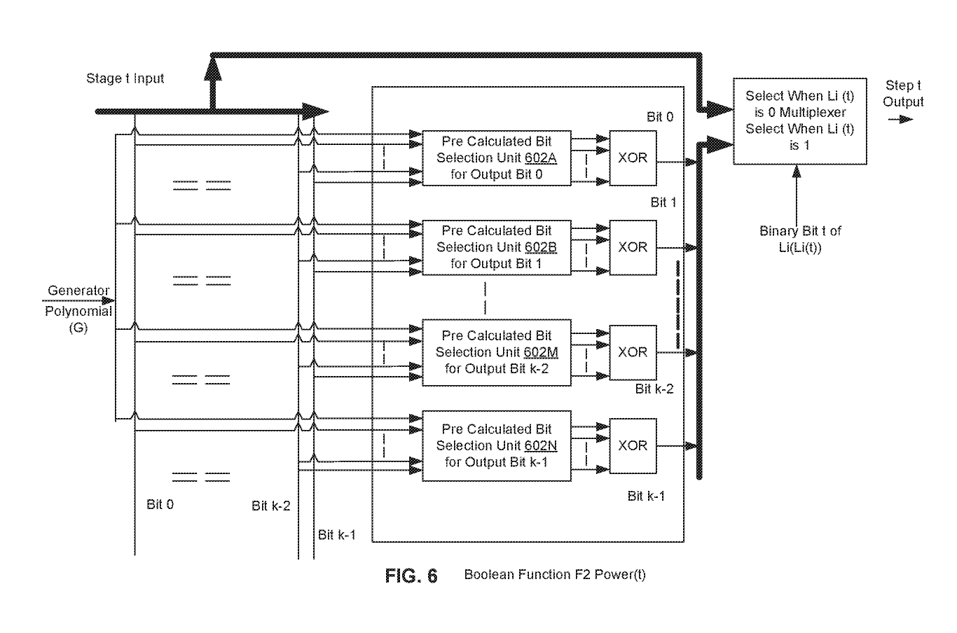

FIG. 6 is an exploded view of the Boolean function F2power(t) which constitutes a stage in the Boolean function unit 304 of FIG. 5A and FIG. 5B, according to an embodiment herein. The Boolean function unit depicted in FIG. 6 consists of pre calculated bit selection unit 602A-N followed by XOR for each output bit of stage ‘t’. Different pre-determined combinations of input bits Bit 0-Bit (k−1), computed based on the generator polynomial, are selected in each pre calculated bit selection unit. The outputs of each pre calculated bit selection unit are XORed to produce a bit of the output of stage “t”. The input “G” introduces configurability for different generator polynomials; since the functionality of each of the pre calculated bit selection unit 602 depends on the generator polynomial, making the generator polynomial as an input expands the scope of the unit to accommodate various generator polynomials.

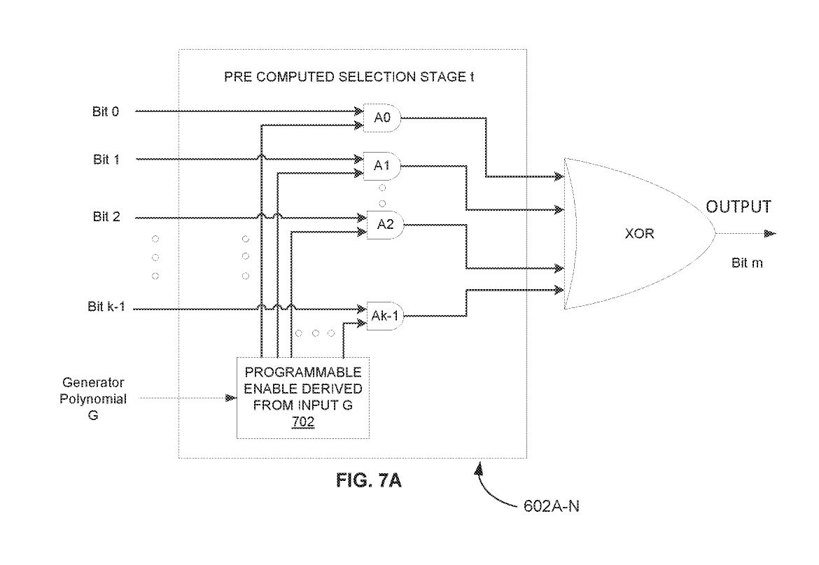

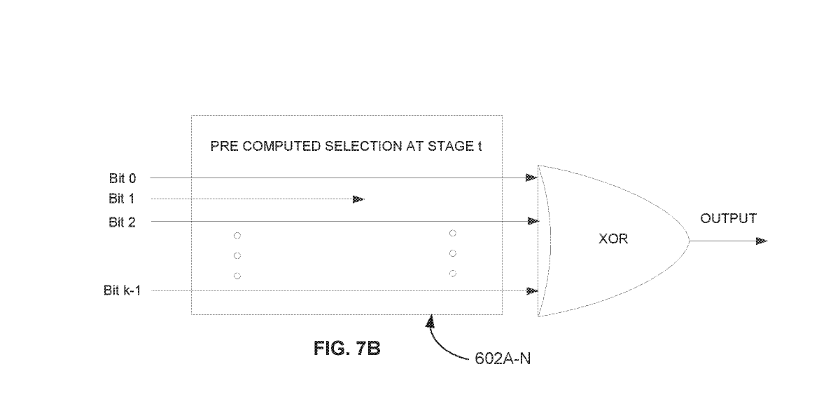

FIG. 7A is an exploded view of the pre calculated bit selection units 602A-N in Boolean Function F2power(t) in FIG. 6 according to an embodiment herein, for output bit ‘m’ of stage ‘t’ and with input generator polynomial “G”. The circuit consists of G based mapping unit 702 for particular value of ‘t’ and ‘m’, and an AND gate associated with each input bit. The input bits Bit0 to Bit (k−1) are ANDed with enable signals from 702. The outputs of the AND gates (A0-Ak−1) are then XORed to get the final output for Bit ‘m’. FIG. 7B is simplified for version of FIG. 7A, when the generator polynomial (G) is pre-determined. As ‘t’, ‘m’ and ‘G’ are known hence the selection of input to XOR is pre-determined.

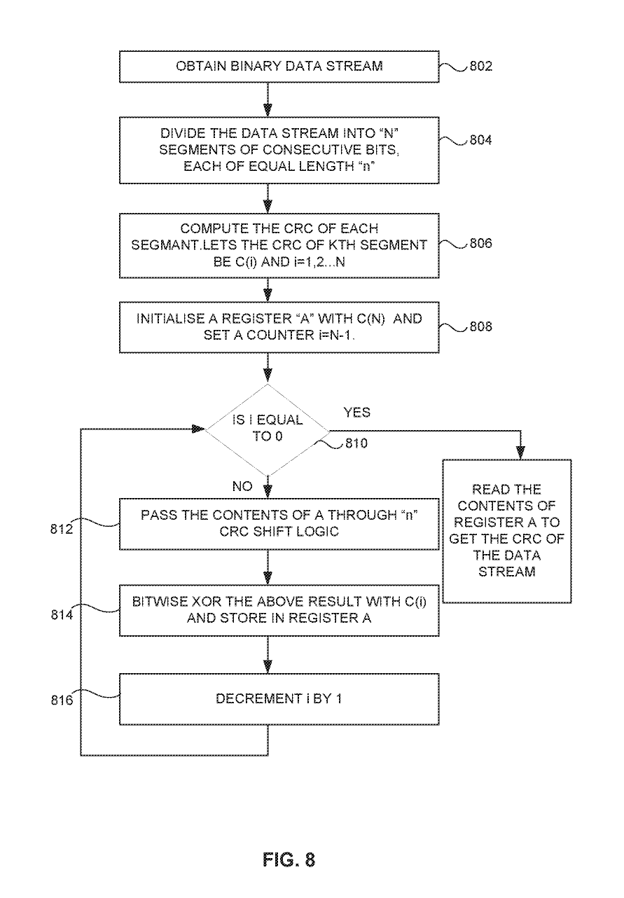

FIG. 8 is a flow diagram illustrates a method of computing a final CRC for an input data stream using the CRC computing system 200 according to an embodiment herein. In step 802, a binary data stream is obtained. In step 804, the data stream is segmented into N segments of consecutive bits. In one embodiment, each consecutive segment is of equal length ‘n’. In step 806, a CRC of each segment is computed. In one embodiment, a CRC of Kₜₕ segment is C₍ᵢ₎ and i=1, 2, . . . N. In step 808, a register is initialized A with C_{(N)} and a counter i=N−1 is set. In step 810, a check is performed for i is equal to 0. When i is equal 0, contents of the register is read to obtain a CRC of the input data stream. Otherwise, in step 812, content is passed through the CRC combiner circuit 204. In step 814, the above result is XORed with C₍ᵢ₎ and stored in the register A. In step 816, i is decremented by 1, and steps 810 to 816 are repeated until i is equal to zero.

The final CRC of the input data stream is computed in accordance with an equation CRC(M)=CRC(CRC(CRC . . . (CRC(CRC(S_{N-1}*x^{L}^{_{N−2}}+S_{N-2})*x^{L}^{_{N−3}}+S_{N-3})*x^{L}^{_{N−4}}+S_{N-4}) . . . *x^{L}^{₁}+S₁)*x^{L}^{₀}+S₀), where CRC(M) represents said final CRC of said input data stream (M), and Sᵢ₊₁*x^{L}^{ᵢ} represents padding Lᵢ zeroes to segment Sᵢ₊₁, as described above in the description of FIG. 3B. The S_{N-1} is a most significant segment, L_{N-2} is a length of a second most significant segment, S_{N-2} is the second most significant segment, L_{N-3} is a length of a third most significant segment, S_{N-3} is the third most significant segment, L_{N-4} is a length of a fourth most significant segment, S_{N-4} is the fourth most significant segment, L₁ is a length of a second least significant segment, S₁ is the second least significant segment, L₀ is a length of a least significant segment, and S₀ is the least significant segment. The final CRC of the input data stream is computed in accordance with an equation CRC(M,G)=F(F . . . (F((F(C_{N-1},L_{N-2},G)+C_{N-2}),L_{N-3},G), . . . +C₁)L₀,G)+C₀), as described above in the description of FIG. 4A. The F is Boolean operation for a particular CRC polynomial, Cᵢ is a CRC of a particular segment i, L_{N-2} is an amount of zero padding based on a length of a third most significant segment,L_{N-3} is an amount of zero padding based on a length of a fourth most significant segment, L₀ is an amount of zero padding based on a length of a least significant segment, and G is a generator polynomial.

The Boolean operation (F), for a particular CRC polynomial G, is implemented in k stages as described above in the description of FIG. 4A, FIG. 5A, and FIG. 5B. A stage ‘t’ of the k stages includes a Boolean function, that performs CRC of an input of the stage ‘t’ padded with 2^{t} zeroes, which may be implemented using a XOR operator per output bit j that ranges from 0 to r−1, on a predetermined set of selected input bits of the stager based on a generator polynomial G, t and j. Each output of the Boolean function may be selected as an output of a stage when a bit Lᵢ₍ₜ₎ is1, where ‘t’ is equal to 0:(k−1). The k stages is equal to r stages, and where r is a number of bits required to represent a length Lᵢ in binary form as Lᵢ₍ᵣ₋₁₎ to Lᵢ₍₀₎, as described above in the description of FIG. 5A and FIG. 5B. A stage ‘t’ of the k stages includes a Boolean function, that performs CRC of an input of the stage ‘t’ padded with 2^{xt} zeroes, implemented using a XOR operator per output bit j that ranges from 0 to r−1, on a predetermined selected input bits of the each stage based on a generator polynomial G, t and j. The ‘t’ ranges from 0 to (k−1) and sum of Xt is Lᵢ, as depicted and described in the FIG. 5A and FIG. 5B.

The Boolean operation (F), for a selectable CRC polynomial G, is implemented in r stages, where r is a number of bits required to represent a length Lᵢ in binary form as Lᵢ₍ᵣ₋₁₎ to Lᵢ₍₀₎, as described and depicted in the FIG. 6. A stage ‘t’ of the r stages includes a Boolean function, that performs CRC of an input of said stage ‘t’ padded with 2^{t} zeroes, which may be implemented using a XOR operator per output bit j that ranges from 0 to r−1, on input bits corresponding to the ‘t’ stage and are selected by G, t, and j. The j is stage output bit position of the stage ‘t’. Each output of the Boolean function may be selected as an output of a stage when a bit Lᵢ₍ₜ₎ is 1, as described and depicted in the FIG. 6. The input data stream includes a plurality of segments of equal size, in one embodiment. In another embodiment, the input data stream includes at least one segment which differs in size with respect to other segments of the plurality of segments.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims,

What is claimed is:

1. A method of performing cyclic redundancy check (CRC) of an input data stream comprising:
a) obtaining plurality of segments corresponding to said input data stream;
b) computing a CRC for each of said plurality of segments for obtaining a plurality of partial CRCs;
c) initializing a register with a partial CRC of N^{th} segment of said plurality of segments, wherein said N^{th} segment is a most significant segment of said plurality of segments of said input data stream;
d) performing a Boolean operation, using at least one Boolean function unit, on said partial CRC of N^{th} segment to obtain a first intermediate CRC based on a length of (N−1)th segment of said plurality of segments;
e) adding said first intermediate CRC to a partial CRC of (N−1)th segment of said plurality of segments to obtain a second intermediate CRC; and
(f) repeating steps d) and e) until a partial CRC associated with a least significant segment of said plurality of segments is added to a first intermediate CRC corresponding to a second segment of said plurality of segments to obtain a final CRC corresponding to said input data stream.

2. The method of claim 1, wherein said final CRC of said input data stream is computed in accordance with an equation CRC(M)=CRC(CRC(CRC . . . (CRC(CRC)S_{N-1}*x^{L}^{_{N−2}}+S_{N-2})*x^{L}^{_{N−3}}+S_{N-3)*x}^{L}^{_{N−4}}+S_{N-4}) . . . *x^{L}^{₁}+S₁)*x^{L}^{₀}+S₀), wherein CRC(M) represents said final CRC of said input data stream (M), and Sᵢ₊₁*x^{L}^{ᵢ} represents padding Lᵢ zeroes to segment Sᵢ₊₁, wherein S_{N-1} is a most significant segment, L_{N-2} is a length of a second most significant segment, S_{N-2} is the second most significant segment, L_{N-3} is a length of a third most significant segment, S_{N-3} is the third most significant segment, L_{N-4} is a length of a fourth most significant segment, S_{N-4} is the fourth most significant segment, L₁ is a length of a second least significant segment, S₁ is the second least significant segment, L₀ is a length of a least significant segment, and S₀ is the least significant segment.

3. The method of claim 1, wherein said final CRC of said input data stream is computed in accordance with an equation CRC(M,G)=F(F . . . (F((F(C_{N-1},L_{N-2},G)+C_{N-2}),L_{N-3},G), . . . +C₁)L₀,G)+C₀), wherein F is Boolean operation for a particular CRC polynomial, Cᵢ is a CRC of a particular segment i, L_{N-2} is an amount of zero padding based on a length of a third most significant segment, L_{N-3} is an amount of zero padding based on a length of a fourth most significant segment, L₀ is an amount of zero padding based on a length of a least significant segment, and G is a generator polynomial.

4. The method of claim 3, wherein said Boolean operation (F), for a particular CRC polynomial G, is implemented in k stages.

5. The method of claim 4, wherein a stage ‘t’ of said k stages comprises a Boolean function, that performs CRC of an input of said stage ‘t’ padded with 2^{t} zeroes, implemented using a XOR operator per output bit j that ranges from 0 to r−1, on a predetermined selected set of input bits of said stage ‘t’ based on a generator polynomial G, t and j, wherein each output of said Boolean function is selected as an output of a stage when a bit Lᵢ₍ₜ₎ is 1, where ‘t’ is equal to 0:(k−1), wherein said k stages is equal to r stages, where r is a number of bits required to represent a length Lᵢ in binary form as Lᵢ₍ᵣ₋₁₎ to Lᵢ₍₀₎.

6. The method of claim 4, wherein a stage ‘t’ of said k stages comprises a Boolean function, that performs CRC of an input of said stage ‘t’ padded with 2^{Xt} zeroes, implemented using a XOR operator per output bit j that ranges from 0 to r−1, on a predetermined set of selected input bits of said each stage based on a generator polynomial G, t and j, where ‘t’ ranges from 0 to (k−1) and sum of Xt is Lᵢ.

7. The method of claim 1, wherein said Boolean operation (F), for a selectable CRC polynomial G, is implemented in r stages, where r is a number of bits required to represent a length Lᵢ in binary form as Lᵢ₍ᵣ₋₁₎ to Lᵢ₍₀₎.

8. The method of claim 7, wherein a stage ‘t’ of said r stages comprises a Boolean function, that performs CRC of an input of said stage ‘t’ padded with 2^{t} zeroes, implemented using a XOR operator per output bit j that ranges from 0 to r−1, on input bits corresponding to said ‘t’ stage and are selected based on G, t and j wherein j is stage output bit position of said stage ‘t’, wherein each output of said Boolean function is selected as an output of a stage when a bit Lᵢ₍ₜ₎ is 1.

9. The method of claim 1, wherein said input data stream comprises a plurality of segments of equal size.

10. The method of claim 1, wherein said input data stream comprises at least one segment which differs in size with respect to other segments of said plurality of segments.

11. A cyclic redundancy check (CRC) combiner circuit comprising:
a register for storing partial CRCs of a plurality of segments corresponding to an input data stream;
at least one Boolean function unit communicatively associated with said register for performing a Boolean operation on partial CRC of an N^{th} segment from among said plurality of segments to obtain an intermediate CRC based on a length of (N−1)^{th} segment of said plurality of segments, wherein said N^{th} is a most significant segment of said plurality of segments of said input data stream; and
an XOR unit communicatively associated with said at least one Boolean function unit for adding said intermediate CRC to a partial CRC of (N−1)^{th} segment of said plurality of segments to obtain a second intermediate CRC.

12. The cyclic redundancy check (CRC) combiner circuit of claim 11, wherein said XOR unit adds a partial CRC associated with a least significant segment of said plurality of segments to a first intermediate CRC corresponding to a second segment of said plurality of segments to obtain a final CRC corresponding to said input data stream.

13. The cyclic redundancy check (CRC) combiner circuit of claim 11, wherein said final CRC of said input data stream is computed in accordance with an equation CRC(M)=CRC(CRC(CRC . . . (CRC(CRC(S_{N-1}*x^{L}^{_{N−2}}+S_{N-2})*x^{L}^{_{N−3}}+S_{N-3})*x^{L}^{_{N−4}}+S_{N-4}) . . . *x^{L}^{₁}+S₁)*x^{L}^{₀}+S₀), wherein CRC (M) represents said final CRC of said input data stream (M), and Sᵢ₊₁*x^{L}^{ᵢ} represents padding Lᵢ zeroes to Sᵢ₊₁, wherein S_{N-1} is a most significant segment, L_{N-2} is a length of a second most significant segment, S_{N-2} is the second most significant segment, L_{N-3} is a length of a third most significant segment, S_{N-3} is the third most significant segment, L_{N-4} is a length of a fourth most significant segment, S_{N-4} is the fourth most significant segment, L₁ is a length of a second least significant segment, S₁ is the second least significant segment, L₀ is a length of a least significant segment, and S₀ is the least significant segment.

14. The cyclic redundancy check (CRC) combiner circuit of claim 11, wherein said final CRC of said input data stream is computed in accordance with an equation CRC(M,G)=F(F . . . (F((F(C_{N-1}, L_{N-2},G)+C_{N-2}),L_{N-3},G), . . . +C₁)L₀,G)+C₀), wherein F is Boolean operation for a particular CRC polynomial, Cᵢ is a CRC of a particular segment i, L_{N-2} is an amount of zero padding based on a length of a third most significant segment, L_{N-3} is an amount of zero padding based on a length of a fourth most significant segment, L₀ is an amount of zero padding based on a length of a least significant segment, and G is a generator polynomial.

15. The cyclic redundancy check (CRC) combiner circuit of claim 11, wherein said Boolean operation (F), for a particular CRC polynomial G, is implemented in k stages.

16. The cyclic redundancy check (CRC) combiner circuit of claim 15, wherein a stage ‘t’ of said k stages comprises a Boolean function, that performs CRC of an input of said stage ‘t’ padded with 2^{t} zeroes, implemented using a XOR operator per output bitj that ranges from 0 to r−1, on a predetermined set of selected input bits of said stage ‘t’ based on a generator polynomial G, t and j, wherein each output of said Boolean function is selected as an output of a stage when a bit Lᵢ₍ₜ₎ is 1, where ‘t’ is equal to 0:(k−1), wherein said k stages is equal to r stages, where r is a number of bits required to represent a length Lᵢ in binary form as Lᵢ₍ᵣ₋₁₎ to Lᵢ₍₀₎.

17. The cyclic redundancy check (CRC) combiner circuit of claim 15, wherein a stage ‘t’ of said k stages comprises a Boolean function, that performs CRC of an input of said stage ‘t’ padded with 2^{Xt} zeroes, implemented using a XOR operator per output bit j that ranges from 0 to r−1, on a predetermined selected input bits of said each stage based on a generator polynomial G, t and j, where ‘t’ ranges from 0 to (k−1) and sum of Xt is Lᵢ.

18. The cyclic redundancy check (CRC) combiner circuit of claim 11, wherein said Boolean operation (F), for a selectable CRC polynomial G, is implemented in r stages, where r is a number of bits required to represent a length Lᵢ in binary form as Lᵢ₍ᵣ₋₁₎ to Lᵢ₍₀₎.

19. The cyclic redundancy check (CRC) combiner circuit of claim 18, wherein a stage ‘t’ of said r stages comprises a Boolean function, that performs CRC of an input of said stage ‘t’ padded with 2^{t} zeroes, implemented using a XOR operator per output bit j that ranges from 0 to r−1, on input bits corresponding to said ‘t’ stage and are selected based on G, t and j wherein j is stage output bit position of said stage ‘t’, wherein each output of said Boolean function is selected as an output of a stage when a bit Lᵢ₍ₜ₎ is 1.

20. The cyclic redundancy check (CRC) combiner circuit of claim 11, wherein said input data stream comprises a plurality of segments of equal size.
